(19) United States
(12) Patent Application Publication
(10) Pub. No.: US 2011/0311360 A1
(43) Pub. Date: Dec. 22, 2011

(54) OFFSHORE WIND TURBINE

(76) Inventor: Øyvind Nedrebø, Sandvika (NO)

(21) Appl. No.: 13/148,329

(22) PCT Filed: Feb. 9, 2010
(86) PCT No.: PCT/NO2010/000047

§ 371 Date: Aug. 8, 2011

(30) Foreign Application Priority Data
Feb. 10, 2009 (NO) 2009 0625

(51) Int. Cl. F03D 11/04

(52) U.S. Cl. 416/85

(57) ABSTRACT

Offshore wind turbine which includes at least one floating body supporting a wind turbine tower with belonging rotor and machinery house containing components necessary for production of energy based on wind. The at least one floating body consists of a buoyancy body, spacer and ballast structure, the floating body being connected to a steering arm which is further connected to a connecting structure having a turntable which is connected to anchor lines tied to seabed anchors.

The present application relates to an offshore wind turbine plant which comprises at least one floating body supporting a wind turbine tower with belonging rotor and machinery house containing components necessary for production of energy based on wind.

Different solutions for floating offshore wind turbine plants are known.

In Teknisk Ukeblad volume 155, No. 26, August 2008 it is described on page 92-97 three new Norwegian drafts for offshore wind turbine plants, namely Hywind, Sway and Windsea. The Windsea draft consists of a floating platform having three pylons with turbine and rotor. The horizontal distance between the pylons is increasing for increasing height. The platform consists of three framework connected cylindrical legs, and it is anchored to the seabed through a turret which secures that the installation may turn against the wind. Several anchors are fastened to the turret in the centre of the unit. The anchor system and infrastructure to shore are connected to the turret with belonging cables. The platform legs have mounted bottom plates which have larger diameter than the legs.

A floating wind turbine plant may further e.g. be based on a traditional hull of a ship/barge or a floating platform having large draught.

An important property of a floating wind turbine plant is the floating stability. A plant shall in the in case of strong wind and high waves remain stable and without damage.

A floating offshore wind turbine plant may from time to time be exposed to storm induced ocean waves of considerable extent. Accordingly also characteristic response from occurring waves will be a further important property of a floating wind turbine plant.

A column stabilized unity has less wave induced movements than hulls of ships/barges, whereas a floating platform having large draught is the alternative which is less effected of passing of big ocean waves.

A wind turbine rotor has the intended effect that the wind speed immediately in lee of the rotor shall be considerable reduced in relation to the wind speed in the front of the rotor and the speed of the air flow which passes parallel outside the range of the rotor. The energy content of the wind is set by the square of the current wind speed. Because of this it will be important for a wind turbine park that the wind turbines are not arranged in such a way that they give shadow problems for each other and thereby reduce the production of energy. In addition to loss of production of energy turbulence may make a problem for a wind turbine plant if rotors are located too close to each other. Turbulence is giving increasing risk for wear damage and costs.

In relation to the above the wind turbines in the existing wind parks are located with great mutual distance, and typical mutual distance may be approximately five times the rotor diameter. The rotor diameter of wind turbine plants at sea may be 120 m or more.

Hywind/Sway are floating concepts having one wind turbine rotor only. A wind turbine park consisting of such units is therefore taught with great mutual distances, like the way it traditionally is done for wind turbine parks on shore. Hywind/Sway will therefore involve a need of a great area which also will involve a comprehensive system with anchoring lines and cables to the seabed.

The concept Windsea involve three wind turbine rotors mounted on a common floating unit. For limiting the shadow problem to an acceptable level this concept will cause that the unit will have big physical dimensions with belonging high costs. The Windsea concept may also be sensitive for the possible situations where waves and stream have an influence on the direction of orientation for the unit in a disadvantageous way. Waves and storm will from time to time come from other directions than the prevailing wind direction. With the chosen mooring solution it will for Windsea in such cases be experienced that the floating plant takes a direction of orientation which is disadvantageous for operation on the plant. Dependent on the local conditions on selected locations, this may possibly represent a risk for operation problems for the Windsea concept.

An object of the present invention is to provide an offshore wind turbine plant with a technical solution which is favourable in relation to protection against waves, wind and stream, and also favourable by transport and installation on the field, as well as cost savings in the operation compared to the known and most actual concepts for offshore wind turbine plants.

A second object of the present invention is that the concept claims less need of area for a wind park of a given size than known solutions.

A third object of the present inventions is that the wind turbine plant shall have low operating costs and thus be cost effective in relation to known solutions.

The fourth object of the present invention is that “wind shadow” shall not constitute any problem for the wind turbine plant.

The objects of the present invention are obtained by an offshore wind turbine plant which comprises at least one floating body supporting a wind turbine tower with belonging rotor and machinery house containing components necessary for production of energy based on wind, characterized in that the at least one floating body consists of a buoyancy body, spacer and ballast structure, in that the floating body is connected to a steering arm which is further connected to a connecting structure having a turntable which is connected to anchor lines tied to seabed anchors.

Preferable embodiments of the wind turbine plant are further stated in the dependent claims 2-18.

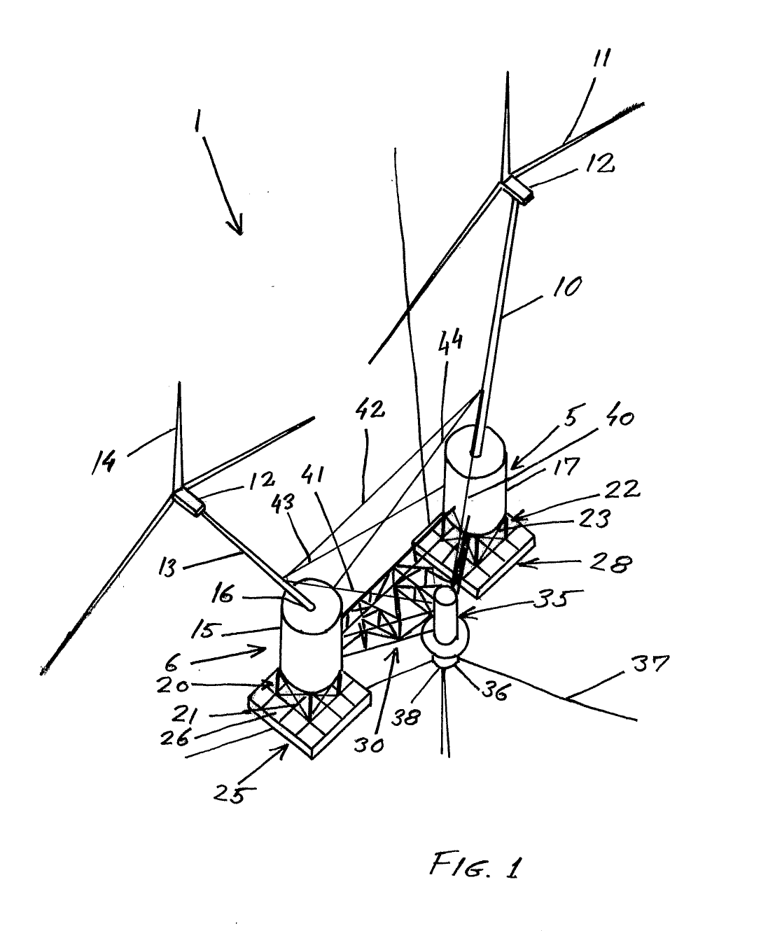

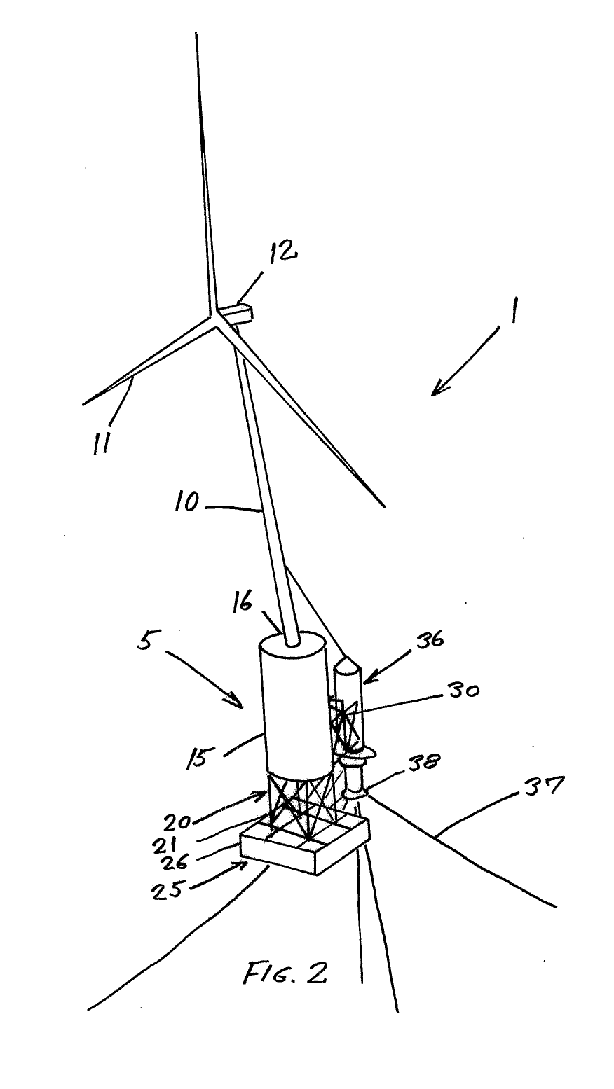

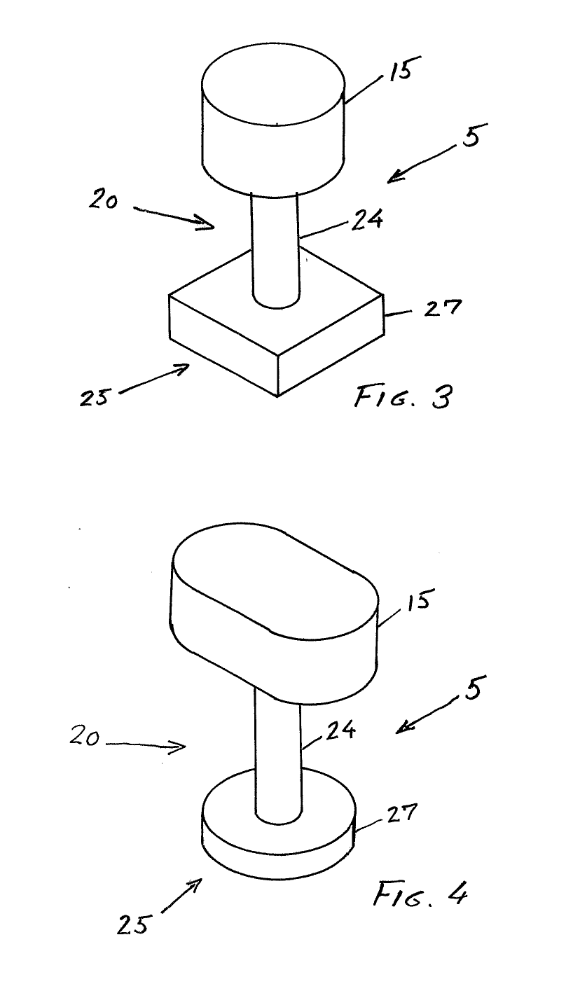

The invention shall in the following be stated in detail with reference to the enclosed drawings, wherein FIG. 1 shows a first embodiment of an offshore wind turbine plant consisting of two floating bodies each having a wind turbine tower, FIG. 2 shows a second embodiment of the offshore wind turbine plant having a floating body with a wind turbine tower, FIG. 3 shows a third embodiment of a floating body designed for a wind turbine tower, in that the floating body has a design which is different from the previous embodiments, and FIG. 4 shows a fourth embodiment of a floating body designed for a wind turbine tower and wherein the floating body has a design which is different from the previous embodiments.

With reference to FIG. 1 it is shown an offshore wind turbine plant which comprises two floating bodies 5, 6 which further support wind turbine towers 10, 13. The wind turbine towers 10, 13 are arranged with a rotor 11, 14 and a machinery house 12, 12 respectively, containing components necessary for production of energy based on wind. The floating bodies 5, 6 consists of a buoyancy body 17, 15, spacer 22, 20 and ballast structure 28, 25. The floating bodies 5, 6 are further connected to a steering arm 30 which again is connected to a connecting structure 35 having turntable 36 which is connected to anchor lines 37 tied to the seabed anchor.

The wind turbine towers 10, 13 are mutual tilted in the same space plane, wherein the horizontal distance between the two wind turbine towers 10, 13 is increasing by increasing height. The wind turbine tower 10, 13 is further connected to a horizontal tension body 42 and connected to tension elements 40, 41 tilted to the top of the connecting structure 35 and tension elements 43, 44 to opposite floating body 5, 6.

The buoyancy bodies 15, 17 are mainly a tubular structure having external plane or curved surfaces against sea and are internal divided in horizontal and vertical waterproof compartments as well as a transition piece 16, 16 for receiving of the wind turbine towers 13, 10. The spacer 20, 22 is in the shown embodiment in FIG. 1, in the form of a framework 21, 23 consisting of bar elements in combination with tension elements. The spacer 20, 22 is in its lower end arranged to the ballast structures 25, 28.

The ballast structures 25, 28 are in the shown embodiment in FIG. 1 formed as a partly open box structure with compartments 26 for arrangement of ballast in solid form. In the shown embodiment in FIG. 1 the ballast structure 25, 28 has a square design. The floating bodies 5, 6 are connected to steering arm 30 which again is connected to the connecting structure 35. The steering arm 30 between the floating bodies 5, 6 and the connecting structure 35 consist of at least one space framework.

The internal turntable 36 of the connecting structure is in the form of a pipe terminated by a flange 38 on a lower level than the upper part of the connecting structure, and the flange 38 is further arranged with the fastening point for the anchor line 37.

The connecting structure 35 and the floating bodies 5, 6 are each arranged with at least one water ballast tank operated by a pump. This makes trim and adjustment of draught of the plant possible.

The steering arm 30 is arranged with intergrated access tunnel between the floating bodies 5, 6 and the connecting structure 35. The steering arm 30 is further arranged with intergrated access tunnel between the floating bodies 5, 6. Access tunnel gives access for inspection/maintenance as well as guiding of equipment cables/equipment for the unit.

The steering arm 30 has panels fastened to structure elements in at least one of the horizontal planes of the structure. Panels are fastened for giving increasing drag resistance and thus reduce possible wind- and wave induced dynamic movements.

The connecting structure 35 is connected with tilted tension elements to the lower part of the floating body 5, 6. This will contribute to increase rigidity and lead tensile force from the anchor line further to the main structure.

Wind turbine tower 10 is connected with a tilted tension element 40 to the top of the connecting structure 35. Tilted wind turbine towers are provided with supporting bars to reduce stress in the lower part of the tower structure itself. Shearing force in the tower caused by wind is directed directly against the mooring point.

The second embodiment of the wind turbine plant 1 which is shown in FIG. 2, contains mainly the same components as the embodiment in FIG. 1, with the exception that this embodiment has a floating body 5 with belonging wind turbine tower 10. Thus the steering arm 30 will have another design as it now connects only one buoyancy body 15 with the turntable 36.

FIG. 3 shows a third embodiment of the floating body of the wind turbine plant. The floating body 5 has here a different design of the spacer 20 and ballast structure 25. The spacer 20 is here in the form of a closed pipe structure 24. The ballast structure 25 is in this embodiment a closed box structure with a square design. The ballast structure 25 may be arranged with openings 27 to the sea.

FIG. 4 shows a fourth embodiment of the floating body of the wind turbine plant where the spacer 20 has a design like the embodiment according to FIG. 3.

The ballast structure 25 is here a closed or partly open box structure with a circular design. The buoyancy body 15 has a design with a rectangular central part which terminates with rounded or semi-circular end parts.

The embodiments according to FIG. 3 and FIG. 4 will in a corresponding way as the embodiment according to FIG. 2 be arranged with the steering arm 30 and connecting structure 35 with belonging equipment. With reference to the embodiments with a wind turbine tower (FIGS. 2, 3 and 4) the wind turbine tower 10 will be tilted in such a way that horizontal distance between points in the central axis of the tower and points in the vertical rotation axis of the connecting structure is increasing with increasing height of the wind turbine tower 10. This gives increasing torque arm beyond the length which is given by the steering arm 30 alone. Thereby it is achieved that the wind power is acting on rotor more efficiently and will contribute to that the floating plant is in the right position in relation to the actual wind direction.

The floating body 5 will be entirely submerged whereby only the wind turbine power 10 rises above the water surface. With this it is obtained quite minimal wave induced movements that are so small that they will not involve adversely on the influence for rotor blades and equipment on the floating plant incidentally.

The connecting structure 35 has at least one external rim at the lower part. External rim will involve increased drag resistance and thereby increase the ability to reduce wind and wave induced dynamic movements.

Mooring lines and equipment cables fastened to the turntable have joint connections in appropriate distance from the turntable and with marking buoys in the surface. Thereby it is obtained that the unity in a simple way may be released from the mooring system and towed to shore with assistance from a vessel.

On each mooring table it is fastened at least one weight between the fastening point on the turntable and fastening point in the anchor on the seabed. Thereby it is achieved partly to move lines against the seabed and steer the lines which lies in lee and are not loaded, in such a way that these do not collide with floating bodies.

Ballast compartments designed for ballast in solid form have filling and draining gates. These are filled/drained by use of a service vessel and ROV. The ballast material is reused. By this it is obtained cost effective ballasting and de-ballasting in connection with maintenance/inspection in sheltered waters.

Ballast compartments for water ballast have a moveable pump with tubes for operation guided up to an approperiate level inside the wind turbine tower. It has also tubes for filling/draining, air duct (windpipe) for tank and additionally power and control cable for operation of pump.

The present invention is shown by preferable embodiments, and in that connection it is to be mentioned that components from one embodiment may be transferred and combined with another embodiment, e.g. the ballast structure 25 from the third and fourth embodiment may also be utilized for the first and second embodiments of the wind turbine 1.

1. An offshore wind turbine plant which comprising:
at least one floating body supporting a wind turbine tower with corresponding rotor and machinery house containing components necessary for production of energy based on wind, the at least one floating body comprising a buoyancy body, spacer and ballast structure, and being to a steering arm which is further connected to a connecting structure having a turntable which is connected to anchor lines tied to seabed anchors.

2. The offshore wind turbine plant according to claim 1, wherein the buoyancy body is substantially a pipe formed structure having external plane or curved surfaces against sea and is internal divided in horizontal and vertical water proof compartments and a transition piece for receiving of wind turbine tower.

3. The offshore wind turbine plant according to claim 1, wherein the ballast structure is a closed or partly open box structure with at least one compartment for placing of ballast in solid form.

4. The offshore wind turbine plant according to claim 1, wherein the ballast structure has a rectangular design.

5. The offshore wind turbine plant according to claim 1, wherein the ballast structure has a circular design.

6. The offshore wind turbine plant according to claim 1, wherein the spacer is in the form of a framework consisting of bar elements in combination with tension elements, the buoyancy body and ballast structure being arranged in the upper and lower end of the spacer, respectively.

7. The offshore wind turbine plant according to claims 1, wherein the spacer is in the form of a closed pipe structure and the buoyancy body and ballast structure are arranged in the upper and lower end of the spacer, respectively.

8. The offshore wind turbine plant according to claim 1, wherein the ballast structure is arranged with openings against the sea.

9. The offshore wind turbine plant according to claim 1, wherein the floating body is entirely submerged, whereby only the wind turbine tower rises over the water surface.

10. The offshore wind turbine plant according to claim 1 wherein the wind turbine tower is arranged in the upper area of the floating body, and the wind turbine tower is further tilted in such a way that the horizontal distance between points in the central axis of the tower and points in the vertical axis of rotation in the connecting structure is increasing at increasing height of the wind turbine tower.

11. The offshore wind turbine plant according to claim 10, wherein the wind turbine tower is connected to a tilted tension element on top of the connecting structure.

12. The offshore wind turbine plant according to claim 1, wherein there are two floating bodies, each having a wind turbine tower mutually tilted in the same space plane, thereby a horizontal distance between the two wind turbine towers is increasing at increasing height, and that the wind turbine towers are connected to a horizontal tension body as well as connected with tension elements to the top of the connecting structure and tension element to the two floating body bodies.

13. The offshore wind turbine plant according to claim 1 wherein the steering arm between the floating bodies and the connecting structure consists of at least one space framework.

14. The offshore wind turbine plant according to claim 1, wherein the internal turntable is in the form of a pipe terminated by a flange on a lower level than the remaining part of the connecting structure, and that-the flange is arranged with fastening points for the anchor lines.

15. The offshore wind turbine plant according to claim 1, wherein the connecting structure and the floating bodies each is arranged with at least one water ballast tank operated by pumps.

16. The offshore wind turbine plant according to claim 1, wherein the steering arm is arranged with an integrated access tunnel between the floating bodies and the connecting structure.

17. The offshore wind turbine plant according to claim 1, wherein the steering arm is arranged with an integrated access tunnel between the floating bodies.

18. The offshore wind turbine plant according to claim 1, wherein the connecting structure is connected by tilted tension elements to the lower part of the floating bodies.

19. The offshore wind turbine plant according to claim 2, wherein the ballast structure is a closed or partly open box structure with at least one compartment for placing of ballast in solid form.

20. The offshore wind turbine plant according to claim 2, wherein the ballast structure has a rectangular design.
